(19) United States
(12) Patent Application Publication
(10) Pub. No.: US 2007/0241140 A1
(43) Pub. Date: Oct. 18, 2007

(54) Hatch with dispensing piston for ice cream making machine with possibility of choosing the form of ice cream dispensed

(76) Inventor: Gino Cocchi, Bologna (IT)

Correspondence Address: Harbin King & Klima, 500 Ninth Street SE, Washington, DC, 20003, US

(21) Appl. No.: 10/577,839

(22) PCT Filed: Oct. 25, 2004
(86) PCT No.: PCT/EP04/52646

§ 371 Date: Feb. 27, 2007

(30) Foreign Application Priority Data
Oct. 29, 2003 (IT) GE2003A000083

(51) Int. Cl. B67D 3/00; A23G 9/04; B67D 5/06; B67D 5/62; B67D 1/08; B65D 5/72

(52) U.S. Cl. 222/509; 222/146.6; 222/571; 222/149; 222/144.5

(57) ABSTRACT

Hatch with dispensing piston for ice cream making machines, characterized in that it comprises at least one cylindrical seat with a vertical axis communicating by means of a radial duct with the freezing cylinder and housing, in a manner rotatable about its axis, a cylindrical sleeve provided with a radial hole and with operating means for aligning in a first portion said hole with the outlet of the radial duct connected to the freezing cylinder, while in a second position this cylindrical sleeve closes off the connection with the freezing cylinder, said sleeve having mounted inside it in an axially slidable manner a dispensing piston, the bottom of said second cylindrical seat being closed off by a base element provided with a plurality of openings suitably shaped for extruding the ice cream. This hatch may be in the form of a single or double hatch.

The present invention relates a hatch with a dispensing piston particularly suitable for ice cream making machines with one or more cylinders, able to allow dispensing, in a physical form chosen from among several forms, of the ice cream dispensed by each cylinder and/or also by the central mixing cylinder in the case of a two-cylinder machine, either simultaneously choosing for example between the classical form of a fretted cone and an elaborate elongated form, such as for example a spaghetti or noodle form, or the like, or in sequence choosing from among several elaborate forms.

In accordance with a characteristic feature of the present invention, this hatch therefore takes the form of both a single hatch or a double hatch, namely a hatch having two parallel cylindrical seats with vertical axes each receiving a piston element, said cylindrical seats being both connected by means of two radial ducts to the same freezing cylinder, one of said seats receiving a normal dispensing piston and being closed at the bottom by a normal base plate provided with a hole fretted in the form of a star or flower or with some other desired profile, while the other seat houses, in a manner rotatable about the axis of the cylinder, a cylindrical sleeve provided with a radial hole and with operating means for aligning in a first position said hole with the outlet of a radial duct connected to the freezing cylinder, while in a second position this cylindrical sleeve closes off the connection with the freezing chamber, said sleeve having mounted inside it in an axially slidable manner a dispensing piston. The bottom of said second cylindrical seat has means for rapid mounting of a base element or element for extruding the ice cream, provided with a plurality of suitably shaped openings, the bottom of the piston co-operating with said extrusion element being provided on its front end with projections complementing the holes of the said extrusion element. Advantageously, means are provided for exact positioning of said second piston in its cylindrical seat inside said sleeve.

Further characteristic features and advantages of the hatch according to the present invention will emerge more fully during the course of the following description of a preferred embodiment thereof, applied to a single cylinder ice cream making machine shown by way of a non-limiting example in the accompanying drawings in which:

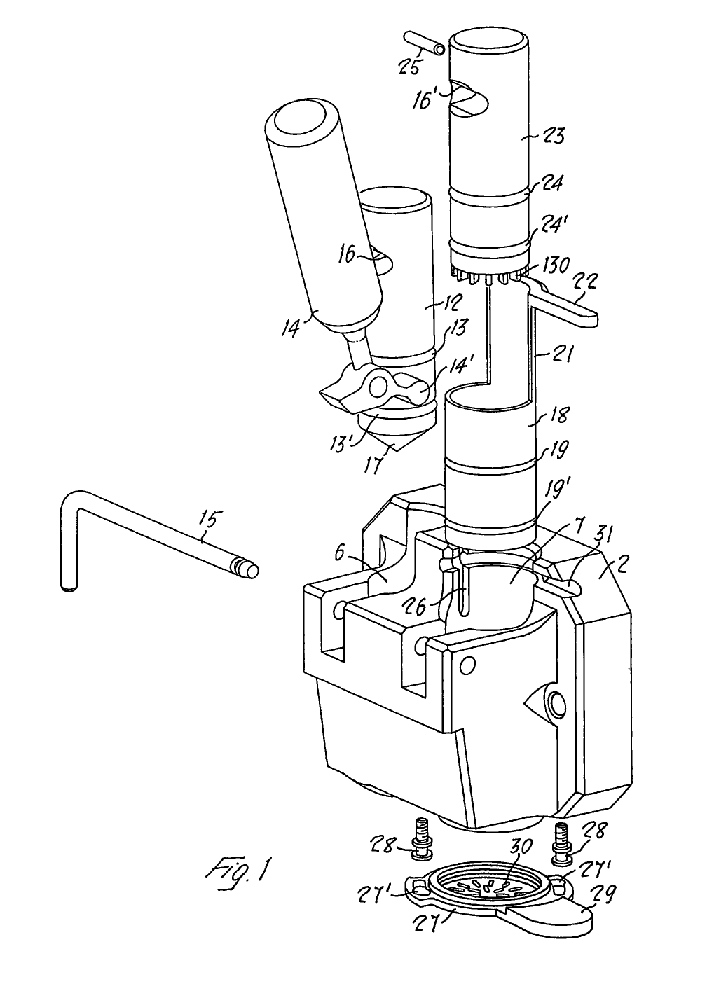

FIG. 1 is an exploded perspective view of a double hatch according to the invention;

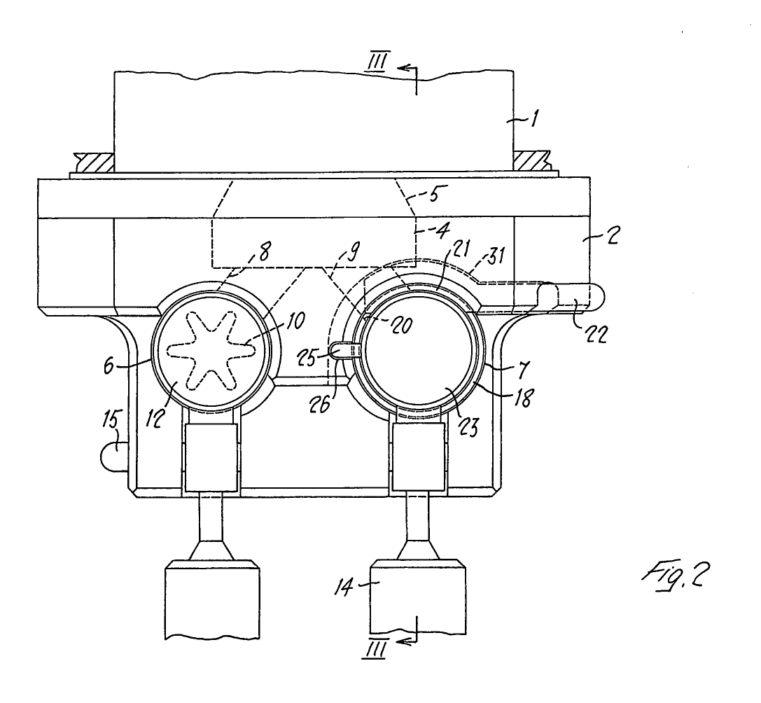

FIG. 2 is a top plan view of the hatch according to FIG. 1; and

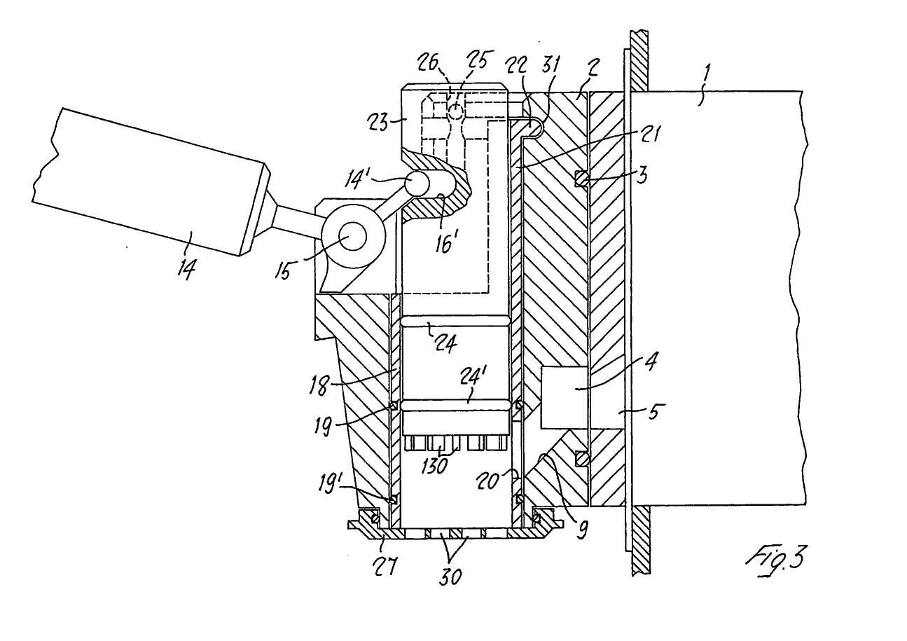

FIG. 3 is a longitudinal cross-sectional view along the plane indicated by the line III-III in FIG. 2, with parts of the hatch according to FIGS. 1 and 2 visible.

With reference to the drawings, 1 denotes the freezing cylinder of a machine for making ice cream. The inlet of this cylinder 1 is closed, in a manner known per se, by the hatch 2, the annular seal 3 of which is made to adhere sealingly against the external flange of this inlet. The hatch 2 has at the bottom thereof a duct 4 which, when the hatch is mounted, is aligned with the dispensing hole 5 of the cylinder 1. The hatch 2 has, formed in it, two cylindrical seats 6 and 7 with parallel and vertical axes, the inside of which communicates, by means of the radial holes, with the ducts 8 and 9 which extend from the main duct 4. One of said cylindrical seats, in the example shown that indicated by the number 6, is closed at the bottom by a wall provided with a hole fretted along its contour in the form of a star, as indicated in broken lines by 10 in FIG. 2. This seat receives a normal dispensing piston 12 (FIG. 1) which is provided in the usual manner with a pair of annular seals 13, 13′ axially spaced from each other and which is operated in the usual manner by means of an operating lever 14 which is pivotably mounted on the pin 15 and one end 14′ of which engages inside a special recess 16 formed in the top part of the cylindrical sleeve of the piston 12, while the bottom end of this piston is shaped in the form of a truncated cone 17.

The second cylindrical seat 7 of the hatch 2 houses, according to the invention, a tubular cylindrical sleeve 18 provided on its outer surface with two parallel seats for housing two axially spaced annular seals 19, 19′ between which a through-hole 20 is formed in a suitable position (FIG. 3) for the purposes which will be described.

From the sleeve 18 there extends upwards a semi-circular lug 21 which has at one end an operating arm 22 projecting radially outwards. 23 denotes a piston able to be slidably inserted inside the sleeve 18. This piston 23 is also provided with a pair of annular seals 24, 24′ in its bottom half, while in the vicinity of its top end it is provided, in a similar manner to the piston 12, with a recess 16′ able to co-operate with the end 14′ of a lever 14 similar to that described with reference to the piston 12. The piston 23 has at its end a radial stud 25 able to be slid inside a longitudinal slit 26 which is open at the top and formed in the side wall of the cylindrical seat 7, for the purposes which will be described below. The bottom of the cylindrical seat 7 is closed by a base plate 27 which is provided laterally with two diametrically opposite eyelets 27′ able to engage with two pins 28 with a mushroom-shaped head projecting from the bottom of the hatch 2, and with a radial operating lug 29. This base plate is provided with a plurality of shaped holes 30 which may have any shape of contour, namely round, oblong, oval, rectangular, star-shaped or the like, and which form the elements for extruding the ice cream, as will be described below. The hatch 2 also has formed therein a recess 31 housing the operating element 22 of the tubular sleeve 18.

The operating principle of the device described will be obvious.

If it is required to dispense a “normal” ice cream, namely an ice cream having a classical form terminating in a fretted upside down cone, the piston 12 is operated in the usual manner.

If, on the other hand, it is required to dispense an ice cream in the form of a bundle of “spaghetti” (or other similar elongated form), the piston 23 is operated, making sure that the lever 22 is situated inside its seat 31, which ensures that the communication hole 20 is aligned with the ice cream supplying duct 9 of the cylinder 1. The ice cream will therefore be extruded through the holes 30 of the extruder 27 and will emerge from this extruder in the form of a bundle of more or less elongated elements. As can be seen, the bottom of the piston 23 has a whole series of small pins 130 projecting downwards and having a form and arrangement complementing that of the holes 30 in the extruder 27. The exact alignment of the pins 130 with the holes 30 is ensured by the correct positioning of the piston 23 inside its sliding seat, said positioning being ensured by the engagement of the pin 25 with the slit 26. Therefore, when the piston 23 is pushed to the end of its downward travel, the pins 130 penetrate inside the holes 30 so as to expel any residual ice cream from the bottom of the said piston, so as to avoid undesirable dripping of said residual ice cream.

If it is required to change the form of the ice cream extruded through the extruder 27, the following sequence of operations is performed:

The tubular sleeve 18 is rotated through 90° by means of the operating element 22. In this way, the hole 20 of the sleeve 18 no longer communicates with the ice cream supplying duct 9, which is instead closed off by the wall of the said sleeve 18. At this point it is possible to extract the piston 23, removing in a known manner the pin 15 so as to disengage the piston 23 from the operating lever 14. This piston is therefore replaced quickly and easily with a new piston intended for extrusion of a new form of ice cream. Once the piston has been reassembled, the extruder 27 is changed with a new extruder corresponding to the type of ice cream chosen and this is performed rapidly by disengaging the old extruder 27 from the pins 28 (achieved in the example shown by means of a small rotation of the old extruder 27 in an anti-clockwise direction and axial withdrawal thereof) and by engaging onto the pins 28 a new extruder 27 corresponding to the new piston installed. Finally, the sleeve is brought back into its operating position, causing it to rotate through 90° until the operating lever 22 is repositioned inside its seat 31.

At this point the device is ready to dispense a new type of ice cream.

Obviously, the present invention is not limited to the embodiment illustrated and described, but comprises all those variations and modifications able to achieve the same result and therefore falling within the wider scope of the inventive idea, substantially as claimed below.

Thus, for example, the hatch may be designed, in a manner known per se, with the possibility of dispensing a “dressing” syrup. Moreover, operation of the pistons, instead of being manual, may be automated. Finally, although a double type hatch has been described, it is understood that the hatch could also be of the type with a single outlet, namely without the “classical” outlet, and could be provided with a whole series of interchangeable pistons and extruders.

Moreover, although the hatch has been illustrated and described as applied to a single-cylinder machine, it is understood that the same could be likewise applied to a twin-cylinder machine, in which case it is possible to envisage duplication of the physical form of the ice cream dispensed, both at the mixing piston of such a twin-cylinder machine, as well as at the two hatches of each cylinder.

1. Hatch with dispensing piston for ice cream making machines, characterized in that it comprises at least one cylindrical seat (7) having a vertical axis communicating by means of a radial duct (4,5) with the freezing cylinder (1) and housing, in a manner rotatable about its axis, a cylindrical sleeve (18) provided with a radial hole (20) and with operating means (22) for aligning in a first position said hole (20) with the outlet of the radial duct (4,5) connected to the freezing cylinder (1), while in a second position this cylindrical sleeve (18) closes off the connection with the freezing cylinder (1), said sleeve having mounted axially slidably inside it a dispensing piston (23), the bottom of said second cylindrical seat (7) being closed off by a base element (27) provided with a plurality of openings (30) suitably shaped for extruding the ice cream.

2. Hatch according to claim 1, with the dual possibility of choosing the form of ice cream dispensed, characterized in that this hatch may be in the form of a double hatch, having two parallel cylindrical seats (6,7) with vertical axes each receiving a piston element (12,23), said cylindrical seats being both connected by means of two radial ducts (8,9) to the same freezing cylinder (1), one of said seats receiving a normal dispensing piston (12) and being closed at the bottom by a normal base plate provided with a fretted or flower-shaped hole (10), while the other seat houses, in a manner rotatable about its axis, a cylindrical sleeve (18) provided with a radial hole (20) and with operating means (22) for aligning in a first position said hole (20) with the outlet of the radial duct (4,5) connected to the freezing cylinder (1), while in a second position this cylindrical sleeve (18) closes off the connection with the freezing cylinder (1), a dispensing piston (23) being mounted in an axially slidable manner inside said sleeve (18), the bottom of said cylindrical seat (7) being provided with a base element (27) provided with a plurality of openings (30) which are suitably shaped for extruding the ice cream.

3. Hatch according to claim 2, in which the bottom of the said piston (23) co-operating with said ice cream extrusion element (27) is provided with projections (130) complementing the holes (30) of the said extrusion element (27).

4. Hatch according to claim 3, characterized in that means (25,26) are provided for exact positioning of said piston (23) inside its cylindrical seat in said sleeve (18) in such a way that the said projections (130) on the bottom of the piston (23) are exactly aligned with the holes (30) in the complementary extrusion element (27).

5. Hatch according to claim 4, characterized in that said pistons (12,23) may be operated both manually and mechanically or in a mixed manual/mechanical manner.

6. Hatch according to claim 5, characterized in that the ice cream dispensing side of said hatch may be associated with means for dispensing a dressing syrup.

7. Hatch according to claim 6, suitable for mounting on a single-cylinder machine.

8. Hatch according to claim 6, suitable for mounting on a machine with several freezing cylinders and in particular a twin-cylinder machine.

9. Hatch according to claim 8, suitable for mounting also at the mixing outlet of the hatch of a twin-cylinder machine.
